(19) United States
(12) Patent Application Publication
(10) Pub. No.: US 2018/0053266 A1
(43) Pub. Date: Feb. 22, 2018

(54) Real Property Valuation System

(71) Applicant: ADP, LLC, Roseland, NJ (US)

(72) Inventors: Debashis Ghosh, Charlotte, NC (US); John Anthony Derrico, Harrington Park, NJ (US)

(21) Appl. No.: 15/242,947

(22) Filed: Aug. 22, 2016

(51) Int. Cl. G06Q 50/16; G06Q 30/02

(52) U.S. Cl. CPC G06Q 50/16; G06Q 30/0278

(57) ABSTRACT

A method and computer program product for analyzing real property. A request for income information for a region in a selected level in a hierarchy of levels in a real property database is received by a computer system. The income information for the region in the selected level in the hierarchy of levels in the real property database is identified by the computer system. The income information in a graphical user interface on a display system is displayed by the computer system. The income information displayed in the graphical user interface on the display system enables performing an operation with respect to the real property.

### BACKGROUND INFORMATION

### 1. Field

The present disclosure relates generally to an improved computer system and, in particular, to a method and apparatus evaluating real properties. Still more particularly, the present disclosure relates to a method and apparatus for identifying accurate values for the real properties.

### 2. Background

Identifying value of real properties is performed for various real property operations. The operations include, for example, project planning, pricing new sales, property development, and other operations. One manner in which the value of the real properties is identified includes analyzing comparables. The comparables are properties with characteristics similar to the property in question that may be compared to identify the value of the real property. For example, factors that are examined for the comparables include conditions of sale, financing conditions, market conditions, vocational comparability, and physical comparability.

However, identifying and evaluating the real properties that are considered to be comparables is subjective. As a result, identifying prices of the real properties may not be as accurate as desired. Further, appraisal data often becomes outdated based on market changes.

Further, the identification of the comparables only provides a snapshot of the value of the real properties in time. This type of analysis is static and does not lend itself to identifying trends for real properties.

Therefore, it would be desirable to have a method and apparatus that take into account at least some of the issues discussed above, as well as other possible issues. For example, it would be desirable to have a method and apparatus that overcome a technical problem with identifying the value of the real properties with a desired level of accuracy.

### SUMMARY

An embodiment of the present disclosure provides a computer system. The computer system comprises a display system, a real property database, and a property analyzer. The real property database comprises income information for people in regions based on locations of the people. The regions are organized into levels in a hierarchy in which a parent region in a first level in the levels is comprised of child regions in a second level in the levels that is below the first level in the hierarchy. The property analyzer is in communication for with the display system and the real property database. The property analyzer received a request for the income information for a region in a selected level in the hierarchy. The property analyzer identifies the income information for the region in the selected level in the hierarchy in the real property database. The property analyzer displays the income information in a graphical user interface on the display system. The income information, which is displayed in the graphical user interface on the display system, enables performing an operation with respect to real property.

Another embodiment of the present disclosure provides a method for analyzing real property. A request for income information for a region in a selected level in a hierarchy of levels in a real property database is received by a computer system. The income information for the region in the selected level in the hierarchy of levels in the real property database is identified by the computer system. The income information in a graphical user interface on a display system is displayed by the computer system. The income information displayed in the graphical user interface on the display system enables performing an operation with respect to the real property.

Yet another embodiment of the present disclosure provides a computer program product for analyzing real property. The computer program product comprises a computer readable storage media, first program code, second program code, and third program code. The first program code, the second program code, and the third program code are stored on the computer readable storage media. The first program code receives a request for income information for a region in a selected level in a hierarchy of levels in a real property database. The second program code identifies the income information for the region in the selected level in the hierarchy of levels in the real property database. The third program code displays the income information in a graphical user interface on a display system. The income information displayed in the graphical user interface on the display system enables performing an operation with respect to real property.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of a block diagram of real property information environment in accordance with an illustrative embodiment;

FIG. 2 an illustration of a block diagram of a record in payroll information in accordance with an illustrative embodiment;

FIG. 3 is an illustration of a block diagram of a graphical user interface in accordance with an illustrative embodiment;

FIG. 4 is an illustration of a record in accordance with an illustrative embodiment;

FIG. 5 is an illustration of a graphical user interface with regions and information about the regions in accordance with an illustrative embodiment;

FIG. 6 is another illustration of a graphical user interface with regions and information about the regions in accordance with an illustrative embodiment;

FIG. 7 is yet another illustration of a graphical user interface with regions and information about the regions in accordance with an illustrative embodiment;

FIG. 8 is still another illustration of a graphical user interface with regions and information about the regions in accordance with an illustrative embodiment;

FIG. 9 is yet another illustration of a graphical user interface with regions and information about the regions in accordance with an illustrative embodiment;

FIG. 10 is another illustration of a graphical user interface with regions and information about the regions in accordance with an illustrative embodiment;

FIG. 11 is an illustration of a flowchart of a process for analyzing real property in accordance with an illustrative embodiment;

FIG. 12 is an illustration of a flowchart of a process for updating a real property database in accordance with an illustrative embodiment;

FIG. 13 is an illustration of a flowchart of a process for updating a real property database with statistical information in accordance with an illustrative embodiment;

FIG. 14 is an illustration of a flowchart of a process for displaying income information in a graphical user interface in accordance with an illustrative embodiment; and

FIG. 15 is an illustration of a block diagram of a data processing system in accordance with an illustrative embodiment.

### DETAILED DESCRIPTION

The illustrative embodiments recognize and take into account one or more different considerations. For example, the illustrative embodiments recognize and take into account that current methodologies for identifying value of real properties are not as accurate as desired. The illustrative embodiments also recognize and take into account that actual rent data and census information are used in identifying the value of real properties. Those embodiments recognize and take into account that this type of information is often inaccurate as entered, is outdated, or both.

Additionally, the illustrative embodiments also recognize and take into account that additional factors should be considered in identifying the value of the real properties. For example, the illustrative embodiments recognize and take into account that identifying a trend in the value of the real properties may be helpful in making an evaluation of the value of a real property. In another example, the illustrative embodiments recognize and take into account that at least one of willingness to pay, ability to pay, or stability of income should be taken into account in evaluating the value of the real properties.

As used herein, the phrase “at least one of”, when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example also may include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

The illustrative embodiments recognize and take into account that other sources of data may be more accurate than those currently used. For example, the illustrative embodiments recognize and take into account that information from payroll databases are more accurate than rent data and census data when analyzing attributes such as willingness to pay, ability to pay, and stability of income.

Thus, the illustrative embodiments provide a method and apparatus for analyzing real properties. In one illustrative example, a computer system receives a request for income information for a region in a selected level in a hierarchy of levels in a real property database. The computer system identifies the income information for the region in the selected level in the hierarchy in the real property database and displays the income information in a graphical user interface on a display system. The income information displayed in the graphical user interface on the display system enables performing an operation with respect to the real property.

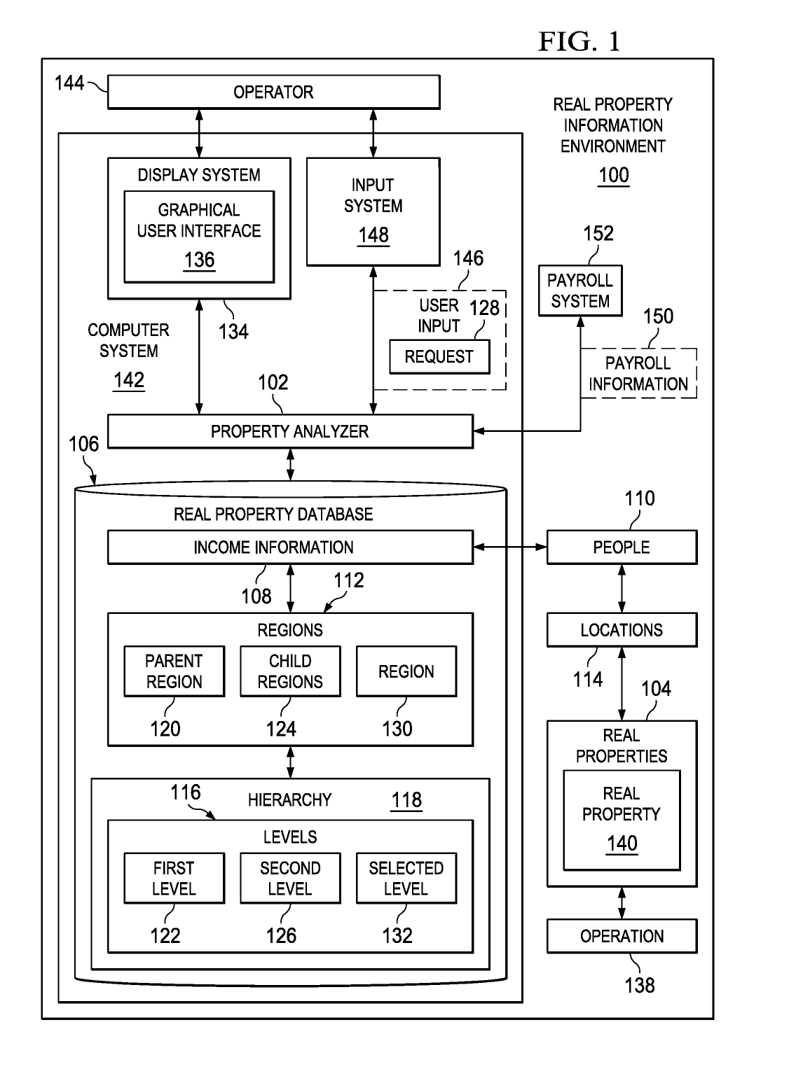

With reference now to the figures and, in particular, with reference to FIG. 1, an illustration of a block diagram of a real property information environment is depicted in accordance with an illustrative embodiment. Real property information environment 100 includes property analyzer 102. Property analyzer 102 may be used to analyze real properties 104. Real properties 104 may include at least one of land, land with improvements, land with crops, or land with natural resources.

As depicted, property analyzer 102 is in communication with real property database 106. Property analyzer 102 analyzes real properties 104 using real property database 106.

In this illustrative example, real property database 106 comprises income information 108 for people 110 in regions 112 based on locations 114 of people 110 in real properties 104. As depicted, regions 112 are organized into levels 116 in hierarchy 118 in which parent region 120 in first level 122 in levels 116 is comprised of child regions 124 in second level 126 that is below first level 122 in hierarchy 118.

In this illustrative example, income information 108 may be derived from payroll information 150 received from payroll system 152. Further, locations 114 also may be derived from payroll information 150. Deriving income information 108 and locations 114 may include at least one of locating the information in payroll information 150 or calculating the information from payroll information 150.

Payroll system 152 may be, for example, in an organization or a payroll company that performs payroll for many organizations in many different geographic locations. For example, payroll system 152 may be a regional payroll system, a nationwide payroll system, or an international payroll system.

Property analyzer 102 receives request 128 for income information 108 for region 130 in selected level 132 in hierarchy 118. Property analyzer 102 identifies income information 108 for region 130 in selected level 132 in hierarchy 118 in real property database 106.

Depending on selected level 132 in hierarchy 118, region 130 may be selected from one of a census block, a block group, a census track, a county, a state, and a region of the county in this particular example. Other types of hierarchies or types of partitions may be used in other examples.

Property analyzer 102 is also in communication with display system 134 and displays income information 108 in graphical user interface 136 on display system 134. Income information 108 is displayed in graphical user interface 136 on display system 134 that enables performing operation 138 with respect to real property 140 in real properties 104.

Property analyzer 102 may be implemented in software, hardware, firmware, or a combination thereof. When software is used, the operations performed by property analyzer 102 may be implemented in program code configured to run on hardware, such as a processor unit. When firmware is used, the operations performed by property analyzer 102 may be implemented in program code and data and stored in persistent memory to run on a processor unit. When hardware is employed, the hardware may include circuits that operate to perform the operations in property analyzer 102.

In the illustrative examples, the hardware may take a form selected from at least one of a circuit system, an integrated circuit, an application specific integrated circuit (ASIC), a programmable logic device, or some other suitable type of hardware configured to perform a number of operations. With a programmable logic device, the device may be configured to perform the number of operations. The device may be reconfigured at a later time or may be permanently configured to perform the number of operations. Programmable logic devices include, for example, a programmable logic array, a programmable array logic, a field programmable logic array, a field programmable gate array, and other suitable hardware devices. Additionally, the processes may be implemented in organic components integrated with inorganic components and may be comprised entirely of organic components, excluding a human being. For example, the processes may be implemented as circuits in organic semiconductors.

Computer system 142 is a physical hardware system and includes one or more data processing systems. When more than one data processing system is present, those data processing systems are in communication with each other using a communications medium. The communications medium may be a network, such as a local area network (LAN), a wide area network (WAN), an intranet, or the Internet. The data processing systems may be selected from at least one of a computer, a server computer, a tablet, or some other suitable data processing system.

In this depicted example, display system 134 is connected to computer system 142. Display system 134 is a physical hardware system and includes one or more display devices on which graphical user interface 136 may be displayed. The display devices may include at least one of a light emitting diode (LED) display, a liquid crystal display (LCD), an organic light emitting diode (OLED) display, or some other suitable device on which graphical user interface 136 can be displayed.

Operator 144 is a person that may interact with graphical user interface 136 through user input 146 generated by operating input system 148 for computer system 142. Input system 148 is a physical hardware system and may be selected from at least one of a mouse, a keyboard, a trackball, a touchscreen, a stylus, a motion sensing input device, a cyber glove, or some other suitable type of input device.

In one illustrative example, one or more technical solutions are present that overcome a technical problem with identifying the value of the real properties with a desired level of accuracy. For example, property analyzer 102 derives income information 108 from payroll information 150 received from payroll system 152. Payroll information 150 provides current and up-to-date information for use in identifying income information 108 for people 110.

As a result, one or more technical solutions may provide a technical effect of improved accuracy in providing information to identify the value of real properties using income information 108. As depicted, income information 108 may be derived from payroll information 150 that is obtained from payroll system 152. In this manner, income information 108 may be at least one of more accurate or more up-to-date as compared to currently used systems.

As a result, computer system 142 operates as a special purpose computer system in which property analyzer 102 in computer system 142 enables ensuring income information 108 in real property database 106 is more accurate as compared to currently used systems. In particular, property analyzer 102 transforms computer system 142 into a special purpose computer system as compared to currently available general computer systems that do not have property analyzer 102. For example, property analyzer 102 may provide a visualization of income information 108 in a manner that is easier for operator 144 to view and use in identifying operation 138 with respect to real property 140. Income information 108 may be displayed in different ones of regions 112 at different ones of levels 116 in hierarchy 118 on graphical user interface 136 on display system 134. The display of income information 108 at different ones of levels 116 provides different visualizations of income information 108 that enable identifying income information 108 for evaluating real properties 104.

Computer system 142 performs a transformation of payroll information 150 into income information 108. The changes are such that the data has a different function or has a different use. Payroll information 150 is typically used for payroll purposes while the transformation into income information 108 allows for evaluating real properties 104.

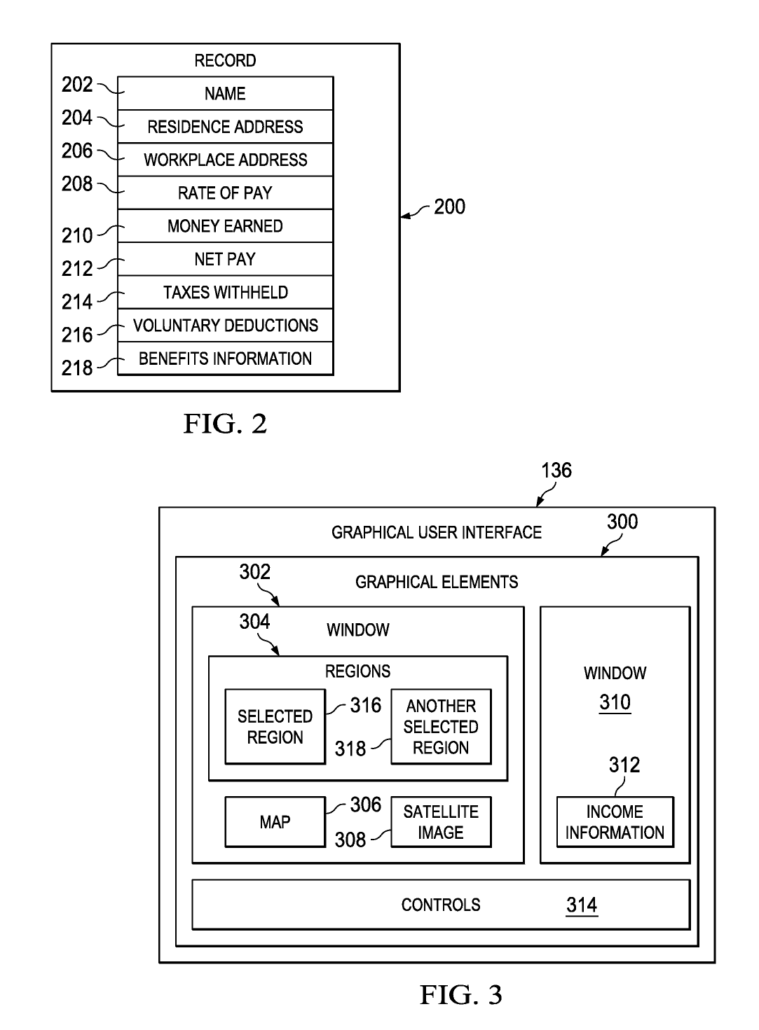

With reference next to FIG. 2, an illustration of a block diagram of a record in payroll information is depicted in accordance with an illustrative embodiment. In this depicted example, record 200 is an example of a record in payroll information 150 in FIG. 1.

In this illustrative example, record 200 has a number of different fields. As depicted in this illustrative example, record 200 includes name 202, residence address 204, workplace address 206, rate of pay 208, money earned 210, net pay 212, taxes withheld 214, voluntary deductions 216, and benefits information 218.

Name 202 is the name of a person for which location information is identified. In this illustrative example, name 202 is not included in income information 108 in real property database 106 in FIG. 1.

In this example, residence address 204 and workplace address 206 are locations 114, as depicted in FIG. 1, for the person. These addresses are used by property analyzer 102 in FIG. 1 to identify locations 114 in regions 112 in real property database 106 in FIG. 1. As depicted, locations 114 may include both workplace and resident addresses. In this manner, a more versatile analysis of real properties 104 in FIG. 1 may be used by having both residence address 204 and workplace address 206 used in locations 114.

Rate of pay 208 indicates how the person is paid. Rate of pay 208 may be, for example, an hourly rate, a salary, or some other manner in which the person is paid. Money earned 210 is the amount of money earned by the person in a particular payroll. Net pay 212 is the amount of pay that the person received from a particular payroll after the money has been withheld or deducted from money earned 210.

Taxes withheld 214 is the amount of money withheld for taxes from money earned 210. Taxes withheld 214 may include at least one of state taxes or federal taxes. Voluntary deductions 216 are amounts that are deducted from money earned 210.

Benefits information 218 identifies benefits for the person. For example, benefits information 218 may include an identification of vacation days and sick days for the person. Benefits information 218 also may include retirement contributions for an individual retirement account (IRA), a 401(k) account, or some other suitable type of retirement vehicle.

With reference now to FIG. 3, an illustration of a block diagram of a graphical user interface is depicted in accordance with an illustrative embodiment. In the illustrative examples, the same reference numeral may be used in more than one figure. This reuse of a reference numeral in different figures represents the same element in the different figures.

In this illustrative example, an example of one implementation of graphical user interface 136 is shown. In this figure, graphical user interface 136 comprises graphical elements 300 that are used to display income information 108 in real property database 106 in FIG. 1.

In this example, window 302 in graphical elements 300 displays regions 304. Regions 304 are all of the same level in hierarchy 118 in FIG. 1 in real property database 106. The display of regions 304 takes a number of different forms. For example, regions 304 may be displayed in at least one of map 306 or satellite image 308 in window 302.

Further, graphical elements 300 also includes window 310 in which income information 312 is displayed. Income information 312 is a visualization of at least some of income information 108 in FIG. 1 in real property database 106. For example, income information 312 may be displayed in graphical form in window 310 and may include at least one of text, icons, a graphic, highlighting, bolding, color, or other types of graphical information.

Further, income information 312 may be derived from income information 108. In other words, calculations, comparisons, or other processing using income information 108 may be used to generate at least some of income information 312 displayed in window 302.

Additionally, graphical elements 300 also include a group of controls 314. The group of controls 314 may be used to interact with graphical user interface 136. For example, the group of controls 314 may be used to change the level of regions 304 displayed in window 302. As another example, the group of controls 314 may be used to focus on selected region 316 in regions 304. In this example, income information 312 is for selected region 316 in regions 304. The group of controls 314 may be used to change focus to another selected region 318. This change in focus causes a change in the display of income information 312 to provide a visualization of income information 312 from selected region 316 to another selected region 318.

In this illustrative example, the group of controls 314 may be separate graphical elements. In some illustrative examples, one or more of the group of controls may be integrated within regions 304. In other words, a selection of a region in regions 304 causes a change in the focus to that region in displaying income information 312 in window 310.

The illustration of real property information environment 100 and the different components in FIGS. 1-3 are not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, in FIG. 1, property analyzer 102 may receive payroll information 150 from one or more payroll systems in addition to or in place of payroll system 152. As another example, the processing of payroll information 150 to obtain income information 108 may be performed in a number of different ways. As another example, record 200 may also include other fields in addition to or in place of the ones shown in FIG. 2. For example, record 200 also may include a field for Social Security, insurance withholdings, or other suitable information.

In another illustrative example, property analyzer 102 in FIG. 1 may run on multiple threads. In other words, different instances of property analyzer 102 may run at the same time or concurrently in computer system 142 in FIG. 1.

For example, a first instance of property analyzer 102 may run on a first thread and a second instance of property analyzer 102 may run on a second thread. These two instances of property analyzer 102 may run at substantially the same time to process payroll information 150 in FIG. 1. For example, payroll information 150 from different payroll systems may be processed in which payroll information 150 from each of the payroll systems is processed by an instance of property analyzer 102 running on a thread that is separate from other instances of property analyzer 102 running on other threads.

In another example, multiple streams of payroll information 150 may be received from payroll system 152 in FIG. 1 in which each stream of payroll information 150 is processed using an instance of property analyzer 102 running on a thread for the instance. In this manner, computer system 142 in FIG. 1 is a special purpose computer system in which payroll may be run for multiple employees at substantially the same time using multiple threads that are executed concurrently on a single processor core or multiple processor cores in a processor unit.

In yet another illustrative example, income information 312 in FIG. 3 may be displayed in another type of graphical element in graphical elements 300. For example, income information 312 may be displayed in a pop-up, a tooltip, or some other suitable manner. In still other illustrative examples, income information 312 may be displayed in window 302.

In another illustrative example, in FIG. 1, real property database 106 may include other information in addition to income information 108. For example, real property database 106 may also include statistical information or other suitable types of information. As yet another example, in FIG. 1, levels 116 for regions 112 may have a hierarchical structure other than that of census information as shown in the illustrative examples. For example, regions 112 may be based on postal codes, area codes, latitude and longitude blocks, or other suitable types of demarcations for physical areas of land.

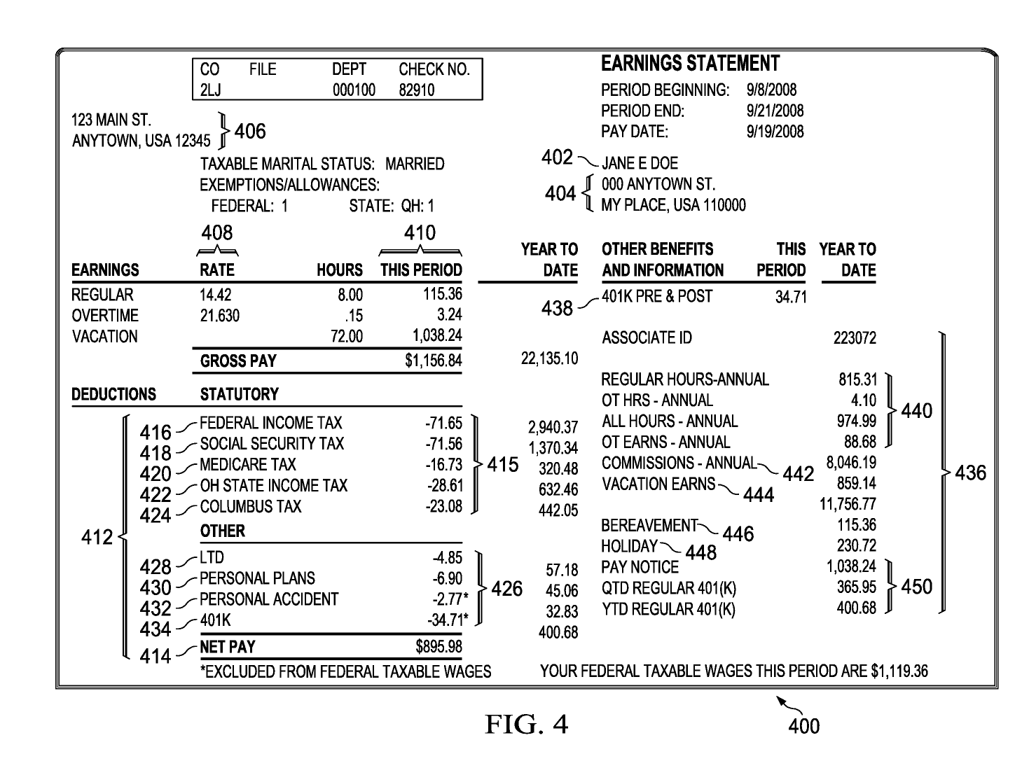

Turning now to FIG. 4, an illustration of a record is depicted in accordance with an illustrative embodiment. In this depicted example, record 400 is a pay statement for an employee. Record 400 is an example of one implementation for record 200 in FIG. 2.

As depicted, record 400 is a pay statement for Jane E. Doe 402 with residence address 404 and workplace address 406. Record 400 also shows rate of pay 408 and money earned 410. Record 400 also includes deductions 412 and net pay 414. Deductions 412 include statutory deductions 415 in the form of federal income tax 416, Social Security tax 418, Medicare tax 420, state income tax 422, and city tax 424 in this example. Other deductions 426 are present in deductions 412 and include long-term disability (LTD) 428, personal plans 430, personal accident 432, and 401k 434. Other benefits and information 436 is also shown in record 400. Other benefits and information 436 include 401k 438, hours 440, commissions 442, vacation 444, bereavement 446, holiday 448, and pay notice 450.

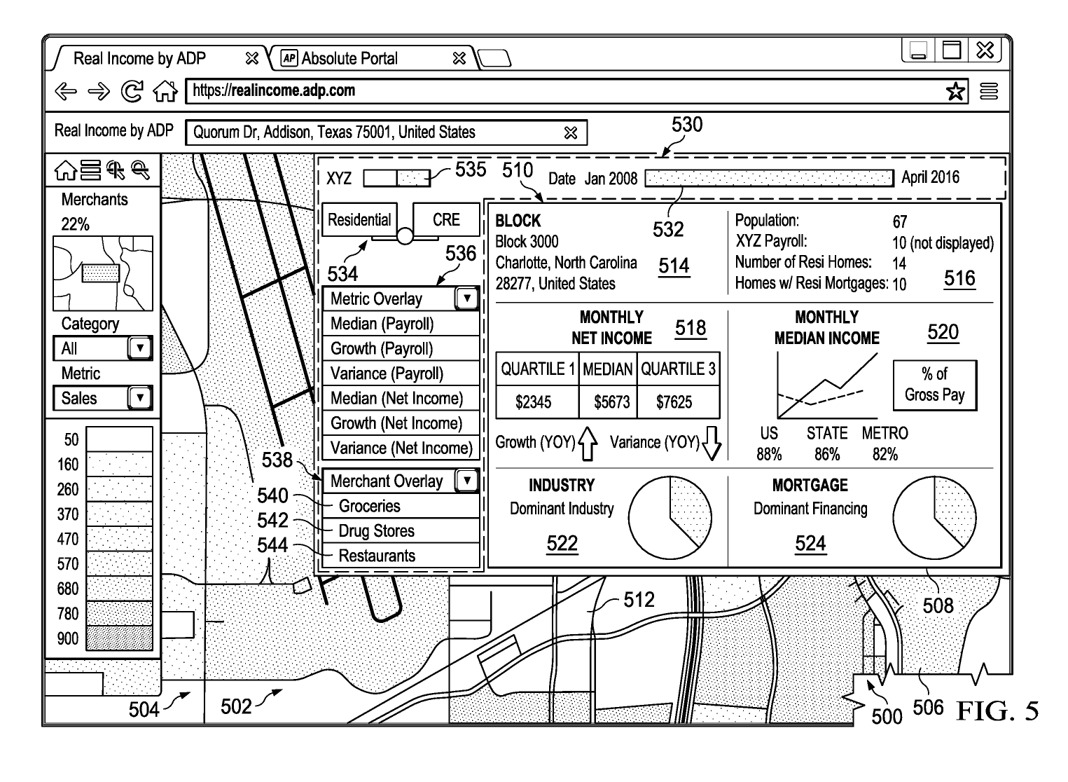

With reference next to FIG. 5, an illustration of a graphical user interface with regions and information about the regions is depicted in accordance with an illustrative embodiment. In this depicted example, graphical user interface 500 is an example of an implementation of graphical user interface 136 shown in block form in FIG. 1 and FIG. 3.

In this illustrative example, graphical user interface 500 includes window 502 in which regions 504 are displayed on map 506. In this example, regions 504 represent blocks in levels or regions in a hierarchy of levels.

Further, window 508 is displayed in which income information 510 is displayed for region 512, which is a particular block in this example. Section 514 shows an identification of the blocks represented by region 512. Section 516 shows information about people in region 512. This information includes, for example, the number of people, the number of people represented in a payroll providing the income information, the number of resident homes, and the number of resident homes with mortgages.

Section 518 shows a monthly net income for region 512. Section 520 shows a monthly medium income for region 512. Section 522 shows information about the industry, and section 524 shows information about mortgages in region 512. As depicted, monthly net income in section 518, monthly medium income in section 520, industry in section 522, and mortgage in section 524 are examples of metrics for region 512.

Additionally, controls 530 are displayed. Slider 532 in controls 530 is used to change the date of income information displayed in window 508. Control 534 in controls 530 is used to select between income information based on residential addresses and income information based on work addresses.

Level selector 535 in controls 530 allows for changing levels in the hierarchy. For example, level selector 535 may be manipulated to change regions 504 from census blocks to some other level such as block groups, census tract, county, or some other suitable level.

Metric selector 536 in controls 530 allows for selecting metrics that are displayed in window 508. Merchant overlay 538 is an example of additional information that may be displayed on map 506 in addition to regions 504. Information such as groceries 540, drug stores 542, and restaurants 544 may be used in performing operations with respect to region 512 and other regions in regions 504.

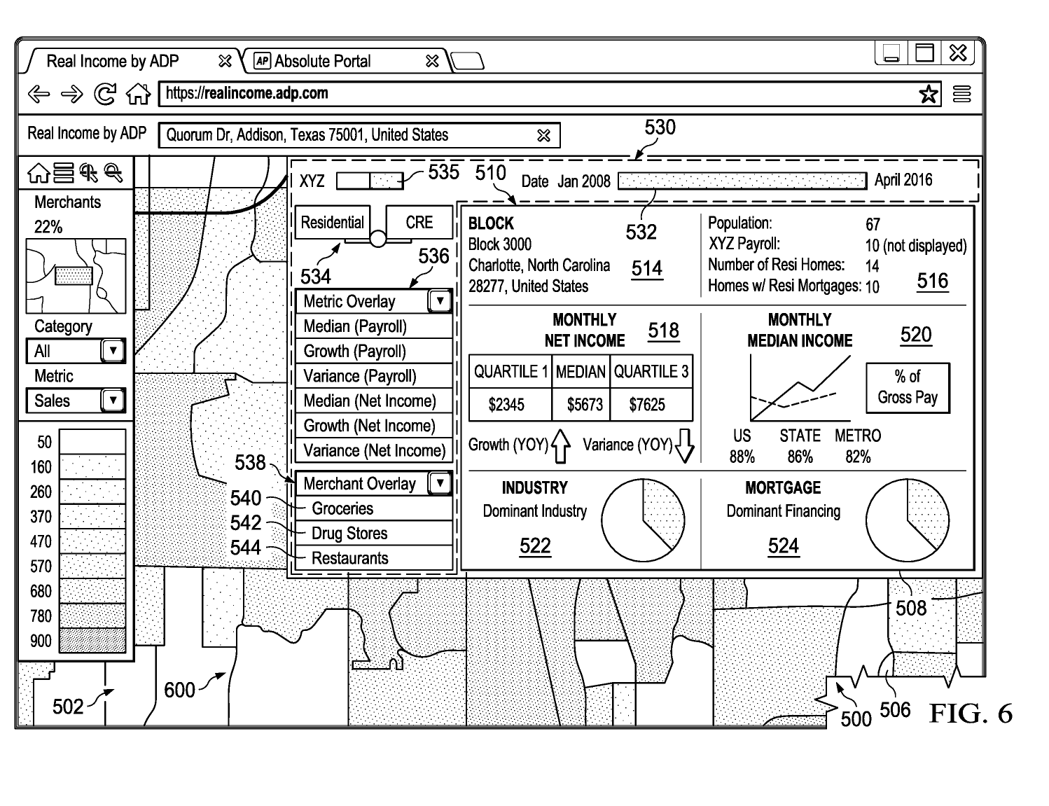

With reference now to FIG. 6, another illustration of a graphical user interface with regions and information about the regions is depicted in accordance with an illustrative embodiment. In this depicted example, graphical user interface 500 now displays regions 600 on map 506 in window 502. Regions 600 represent block groups, which are on a level higher in the hierarchy of regions than regions 504 that represent blocks in FIG. 5. Window 508 now displays income information, metrics, and other information on a block group level for regions 600.

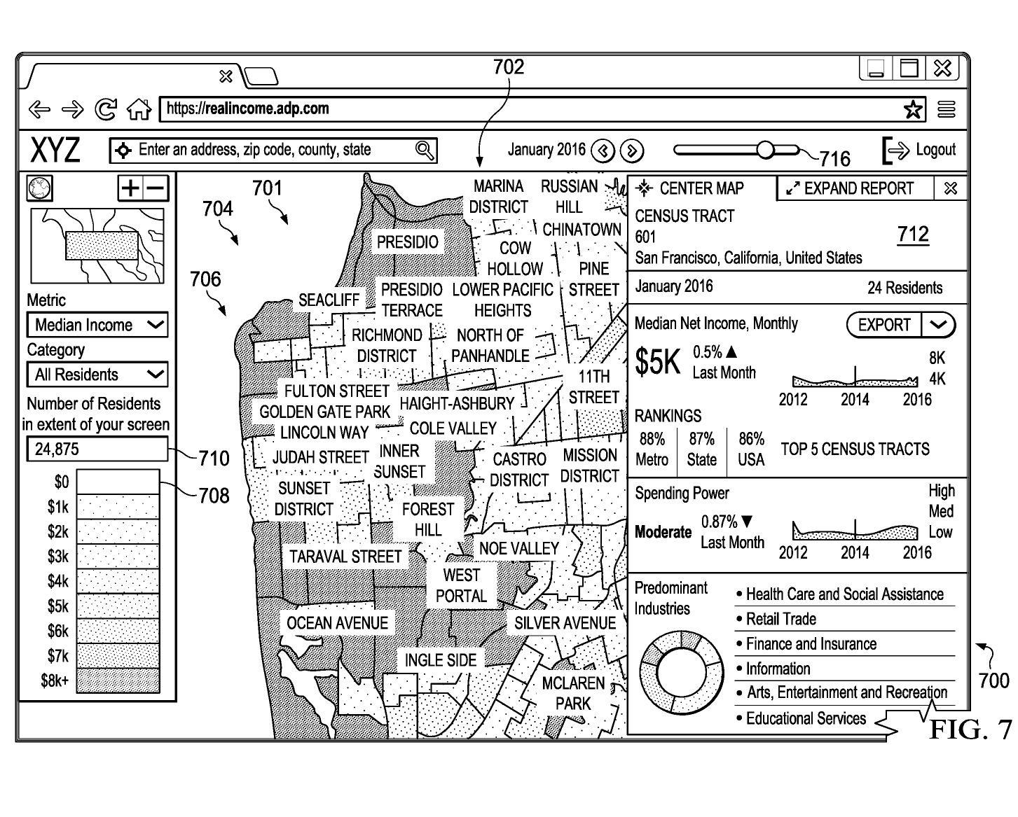

Turning now to FIG. 7, yet another illustration of a graphical user interface with regions and information about the regions is depicted in accordance with an illustrative embodiment. In this depicted example, graphical user interface 700 is an example of one implementation of graphical user interface 136 shown in block form in FIG. 1 and FIG. 3.

In this example, section 701 in window 702 displays regions 704 on map 706. Regions 704 represent census tracts in this illustrative example. Census tracts are on a higher level in the hierarchy than block groups as displayed in FIG. 6.

In this illustrative example, color is used in regions 704 to identify medium income for different census tracts. Key 708 in section 710 indicates the average income for a particular color used in regions 704. Additionally, section 712 in window 702 displays information for residents in region 714 in regions 704.

Further, control 716 is present in window 702. Control 716 is a slider that allows the selection of information for regions 704 to be changed to different dates.

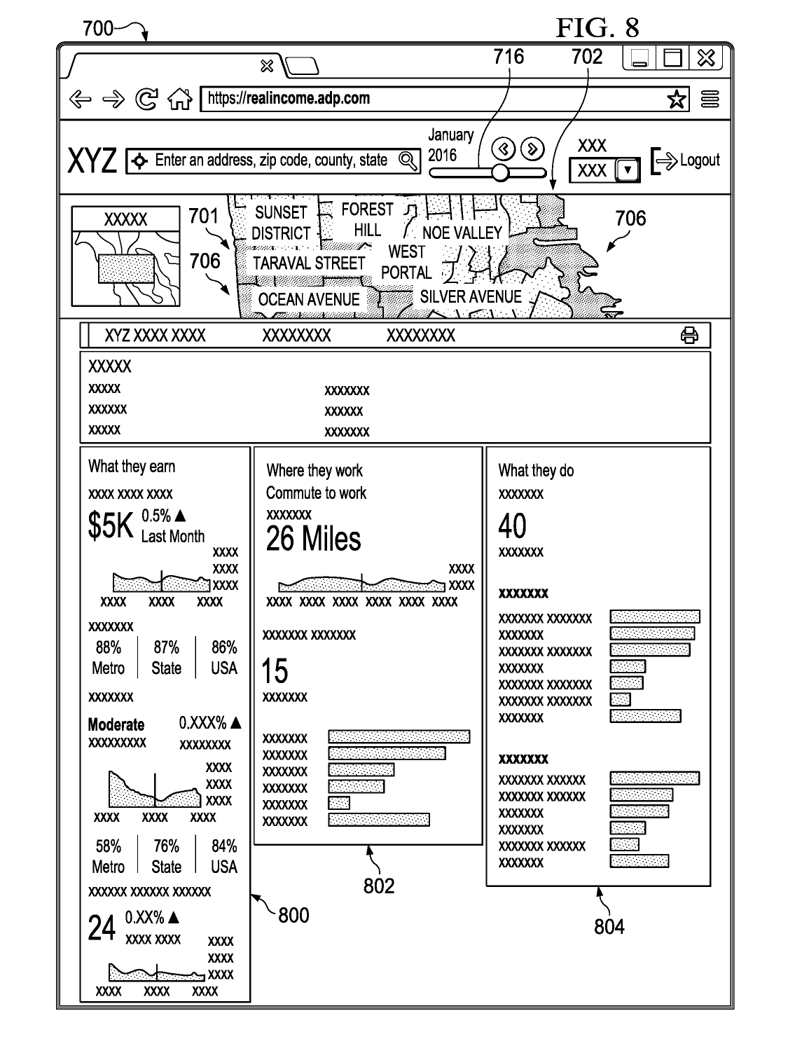

With reference next to FIG. 8, still another illustration of a graphical user interface with regions and information about the regions is depicted in accordance with an illustrative embodiment. In this example, section 800 illustrates earnings for residents in region 714. Section 802 shows where residents in region 714 work. Section 804 show the jobs held by residents in region 714.

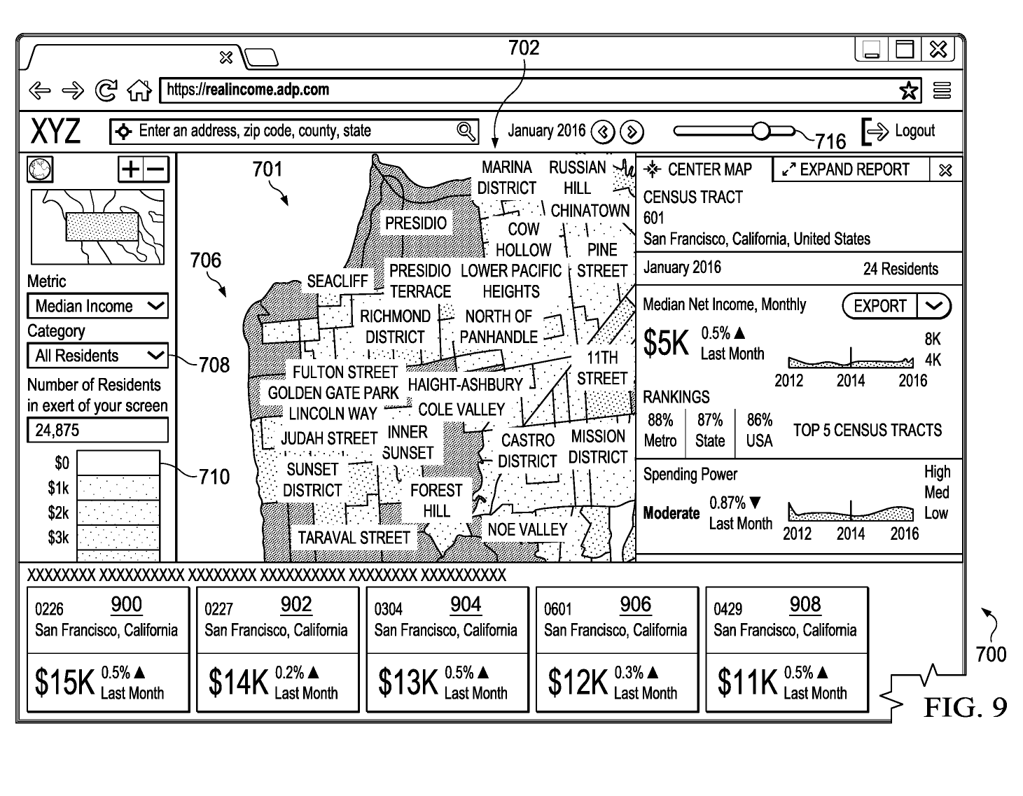

Turning now to FIG. 9, yet another illustration of a graphical user interface with regions and information about the regions is depicted in accordance with an illustrative embodiment. In this example, section 900, section 902, section 904, section 906, and section 908 in window 702 show information for the top five regions in regions 704. In this example, information in the form of net income for residents is shown for the top five census tracts for a city.

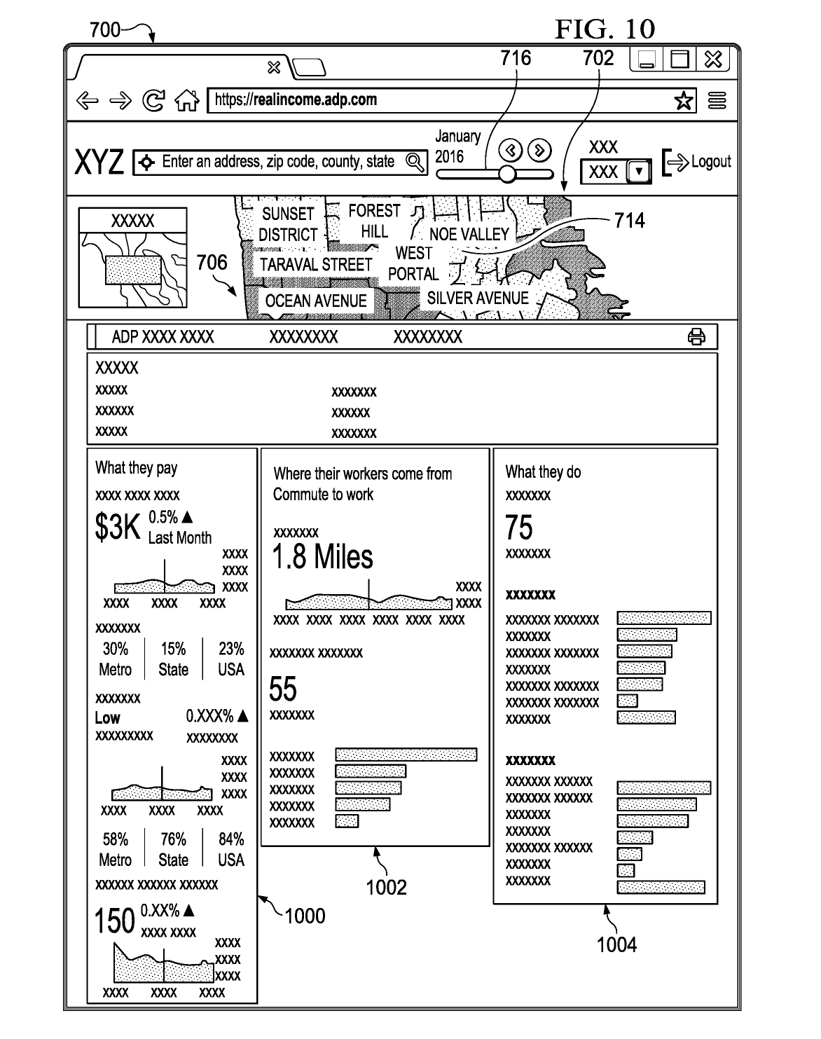

With reference to FIG. 10, another illustration of a graphical user interface with regions and information about the regions is depicted in accordance with an illustrative embodiment. In this example, information for businesses is shown instead of residents in window 702 in graphical user interface 700.

In this example, information is shown for businesses in region 714. This information is shown in section 1000, section 1002, and section 1004 in window 702. As depicted, section 1000 shows net pay by businesses. Section 1002 shows how far employees commute to work in region 714. Section 1004 shows the industries and jobs in region 714.

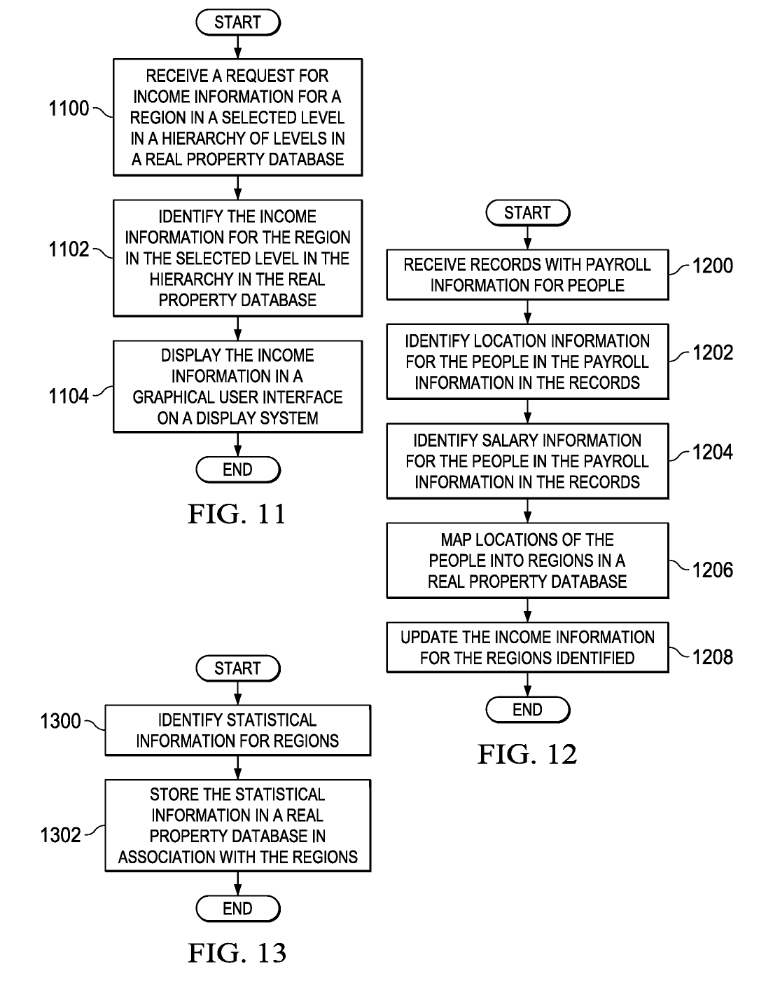

Turning next to FIG. 11, an illustration of a flowchart of a process for analyzing real property is depicted in accordance with an illustrative embodiment. The process in FIG. 11 may be implemented in property analyzer 102 in FIG. 1.

The process begins by receiving a request for income information for a region in a selected level in a hierarchy of levels in a real property database (step 1100). Next, the process identifies the income information for the region in the selected level in the hierarchy in the real property database (step 1102).

The process then displays the income information in a graphical user interface on a display system (step 1104) with the process terminating thereafter. The income information displayed in the graphical user interface on the display system enables performing an operation with respect to the real property.

With reference now to FIG. 12, an illustration of a flowchart of a process for updating a real property database is depicted in accordance with an illustrative embodiment. The process in FIG. 12 may be implemented in property analyzer 102 in FIG. 1 to update real property database 106 in FIG. 1.

The process begins by receiving records with payroll information for people (step 1200). In this example, the records in step 1200 are for a payroll processed for a group of organizations. An organization in the group of organizations may be selected from one of a company, a partnership, a charity, an educational group, a social group, a team, a city, a government agency, or some other suitable organization.

The process then identifies location information for the people in the payroll information in the records (step 1202). The location information is selected from at least one of a residence address or a workplace address in step 1202.

Next, the process identifies salary information for the people in the payroll information in the records (step 1204). The payroll information is selected from at least one of a rate of pay, money earned, a net pay, taxes, voluntary deductions, benefits information, retirement contributions, or other suitable information.

The process then maps locations of the people into regions in a real property database (step 1206). The process updates the income information for the regions identified (step 1208) with the process terminating thereafter. The income information in the regions is updated using the location information and the salary information.

In the illustrative example, the income information for each region is identified using the payroll information. For example, the income information for a region in a higher level in the hierarchy is identified using the payroll information for the people in that region. In another example, the income information for a selected region may be calculated using the income information already calculated for the regions that are lower in the hierarchy that are within the selected region.

With reference next to FIG. 13, an illustration of a flowchart of a process for updating a real property database with statistical information is depicted in accordance with an illustrative embodiment. The process in this flowchart may be implemented in property analyzer 102 to add statistical information to real property database 106 in FIG. 1.

The process identifies statistical information for regions (step 1300). The statistical information for a region may include, for example, at least one of demographic information, a monthly net income, a monthly medium income, age, a number of residential homes, a number of commercial properties, the dominant industry, the dominant financial institution, or other suitable information about the region.

The process stores the statistical information in a real property database in association with the regions (step 1302). Storing the statistical information associated with the regions may be performed by using pointers, indexes, or other mechanisms for associating pieces of information with each other. The process terminates thereafter.

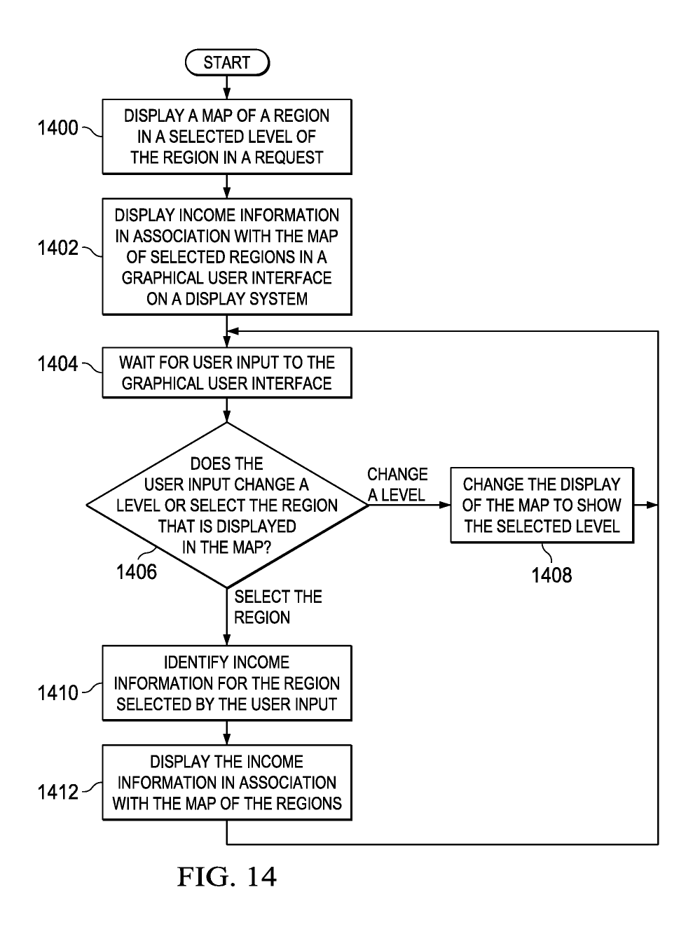

Turning to FIG. 14, an illustration of a flowchart of a process for displaying income information in a graphical user interface is depicted in accordance with an illustrative embodiment. The process illustrated in FIG. 14 may be implemented in property analyzer 102 in FIG. 1 to display income information 108 in graphical user interface 136 on display system 134 in FIG. 1.

The process begins by displaying a map of a region in a selected level of the region in a request (step 1400). The process displays income information in association with the map of selected regions in a graphical user interface on a display system (step 1402).

The process then waits for user input to the graphical user interface (step 1404). When the user input is received, a determination is made as to whether the user input changes the level or selects the region that is displayed in the map (step 1406). If the user input changes the level, the process changes the display of the map to show the selected level (step 1408). The process then returns to step 1404.

With reference again to step 1406, if the user input selects a region, the process identifies income information for the region selected by the user input (step 1410). The process then displays the income information in association with the map of the regions (step 1412) with the process returning to step 1404.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks may be implemented as program code, hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware. Each block in the flowcharts or the block diagrams may be implemented using special purpose hardware systems that perform the different operations or combinations of special purpose hardware and program code run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

For example, the process in FIG. 11 may also display other information in addition to income information in step 1104. For example, the process may also display the statistical information for the region in the graphical user interface on the display system.

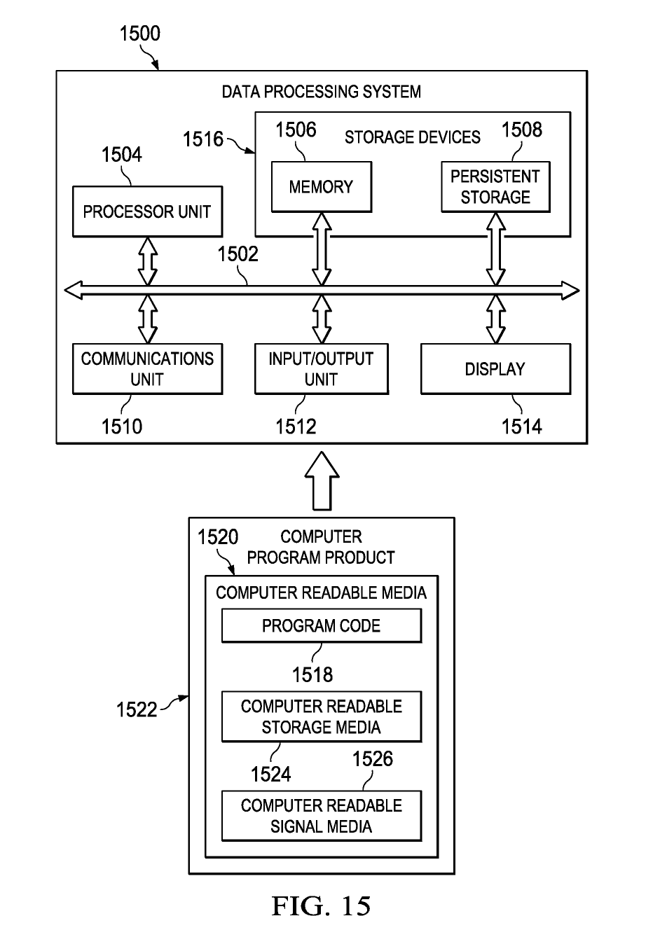

Turning now to FIG. 15, an illustration of a block diagram of a data processing system is depicted in accordance with an illustrative embodiment. Data processing system 1500 may be used to implement computer system 142 in FIG. 1. In this illustrative example, data processing system 1500 includes communications framework 1502, which provides communications between processor unit 1504, memory 1506, persistent storage 1508, communications unit 1510, input/output (I/O) unit 1512, and display 1514. In this example, communications framework 1502 may take the form of a bus system.

Processor unit 1504 serves to execute instructions for software that may be loaded into memory 1506. Processor unit 1504 may be a number of processors, a multi-processor core, or some other type of processor, depending on the particular implementation.

Memory 1506 and persistent storage 1508 are examples of storage devices 1516. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 1516 may also be referred to as computer readable storage devices in these illustrative examples. Memory 1506, in these examples, may be, for example, a random access memory or any other suitable volatile or non-volatile storage device. Persistent storage 1508 may take various forms, depending on the particular implementation.

For example, persistent storage 1508 may contain one or more components or devices. For example, persistent storage 1508 may be a hard drive, a solid state hard drive, a flash memory, a rewritable optical disk, a rewritable magnetic tape, or some combination of the above. The media used by persistent storage 1508 also may be removable. For example, a removable hard drive may be used for persistent storage 1508.

Communications unit 1510, in these illustrative examples, provides for communications with other data processing systems or devices. In these illustrative examples, communications unit 1510 is a network interface card.

Input/output unit 1512 allows for input and output of data with other devices that may be connected to data processing system 1500. For example, input/output unit 1512 may provide a connection for user input through at least one of a keyboard, a mouse, or some other suitable input device. Further, input/output unit 1512 may send output to a printer. Display 1514 provides a mechanism to display information to a user.

Instructions for at least one of the operating system, applications, or programs may be located in storage devices 1516, which are in communication with processor unit 1504 through communications framework 1502. The processes of the different embodiments may be performed by processor unit 1504 using computer-implemented instructions, which may be located in a memory, such as memory 1506.

These instructions are referred to as program code, computer usable program code, or computer readable program code that may be read and executed by a processor in processor unit 1504. The program code in the different embodiments may be embodied on different physical or computer readable storage media, such as memory 1506 or persistent storage 1508.

Program code 1518 is located in a functional form on computer readable media 1520 that is selectively removable and may be loaded onto or transferred to data processing system 1500 for execution by processor unit 1504. Program code 1518 and computer readable media 1520 form computer program product 1522 in these illustrative examples. In one example, computer readable media 1520 may be computer readable storage media 1524 or computer readable signal media 1526.

In these illustrative examples, computer readable storage media 1524 is a physical or tangible storage device used to store program code 1518 rather than a medium that propagates or transmits program code 1518.

Alternatively, program code 1518 may be transferred to data processing system 1500 using computer readable signal media 1526. Computer readable signal media 1526 may be, for example, a propagated data signal containing program code 1518. For example, computer readable signal media 1526 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 1500 are not meant to provide architectural limitations to the manner in which different embodiments may be implemented. The different illustrative embodiments may be implemented in a data processing system including components in addition to or in place of those illustrated for data processing system 1500. Other components shown in FIG. 15 can be varied from the illustrative examples shown. The different embodiments may be implemented using any hardware device or system capable of running program code 1518.

Thus, the illustrative embodiments provide a method and apparatus for evaluating real properties. One or more technical solutions are present that overcome a technical problem with identifying a value of real properties with a desired level of accuracy. For example, a property analyzer derives income information from payroll information received from a payroll system. The use of the payroll information provides current and up-to-date information for use in identifying the income information.

As a result, one or more technical solutions may provide a technical effect of improved accuracy in providing information to identify the value of the real properties using the income information. As depicted, the income information may be derived from the payroll information obtained from the payroll system. In this manner, the income information may be at least one of more accurate or more up-to-date as compared to currently used systems.

Further, the illustrative embodiments provide a method and apparatus for visualizing the income information. In the depicted examples, regions of land may be displayed at different levels in a hierarchy. The income information may be displayed for different regions.

The accuracy of the information, the visualization provided, or both enable valuing the real properties more accurately than with current systems. In this manner, operations may be performed with respect to the real properties.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A computer system comprising:
a display system;
a real property database comprising income information for people in regions based on locations of the people, wherein the regions are organized into levels in a hierarchy in which a parent region in a first level in the levels is comprised of child regions in a second level in the levels that is below the first level in the hierarchy; and
a property analyzer in communication with the display system and the real property database, wherein the property analyzer receives a request for the income information for a region in a selected level in the hierarchy; identifies the income information for the region in the selected level in the hierarchy in the real property database; and displays the income information in a graphical user interface on the display system, wherein the income information displayed in the graphical user interface on the display system enables performing an operation with respect to real property.

2. The computer system of claim 1, wherein the property analyzer receives records with payroll information for people; identifies location information for the people in the payroll information; identifies salary information for the people in the payroll information the records; maps the locations of the people into the regions; and updates the income information for the regions identified, wherein the income information is updated using the salary information and the location information.

3. The computer system of claim 2, wherein the location information is selected from at least one of a residence address or a workplace address.

4. The computer system of claim 2, wherein the salary information is selected from at least one of a rate of pay, money earned, a net pay, taxes, voluntary deductions, benefits information, or retirement contributions.

5. The computer system of claim 1, wherein the property analyzer identifies statistical information for the regions and stores the statistical information in the real property database.

6. The computer system of claim 5, wherein the property analyzer displays the statistical information for the region in the graphical user interface on the display system.

7. The computer system of claim 1, wherein in displaying the income information in the graphical user interface on the display system, the property analyzer displays a map of regions in the selected level for the region in the request; and displays the income information in association with the map of the regions in the graphical user interface on the display system.

8. The computer system of claim 1, wherein the region is selected from one of a census block, a block group, a census track, a county, a state, and a region of the county.

9. A method for analyzing real property, the method comprising:
receiving, by a computer system, a request for income information for a region in a selected level in a hierarchy of levels in a real property database;
identifying, by the computer system, the income information for the region in the selected level in the hierarchy of levels in the real property database; and
displaying, by the computer system, the income information in a graphical user interface on a display system, wherein the income information displayed in the graphical user interface on the display system enables performing an operation with respect to the real property.

10. The method of claim 9 further comprising:
receiving, by the computer system, records with payroll information for people;
identifying, by the computer system, location information for the people in the records;
identifying, by the computer system, salary information for the people using the records;
mapping the locations of the people into regions in the real property database; and
updating, by the computer system, the income information for the regions identified, wherein the income information in the regions is updated using the salary information and the location information.

11. The method of claim 10, wherein location information is selected from at least one of a residence address or a workplace address.

12. The method of claim 9, wherein the income information is selected from at least one of a rate of pay, money earned, a net pay, taxes, voluntary deductions, benefits information, and retirement contributions.

13. The method of claim 9 further comprising:
identifying, by the computer system, statistical information for regions; and
storing, by the computer system, the statistical information in the real property database.

14. The method of claim 13 further comprising:
displaying, by the computer system, the statistical information for the region in the graphical user interface on the display system.

15. The method of claim 9, wherein displaying the income information in the graphical user interface on the display system comprises:
displaying, by the computer system, a map of regions in the selected level of the region in the request; and
displaying, by the computer system, the income information in association with the map of the regions in the graphical user interface on the display system.

16. The method of claim 9, wherein the region is selected from one of a census block, a block group, a census track, a county, a state, and a region of the county.

17. A computer program product for analyzing real property, the computer program product comprising:
a computer readable storage media;
first program code, stored on the computer readable storage media, for receiving a request for income information for a region in a selected level in a hierarchy of levels in a real property database;
second program code, stored on the computer readable storage media, for identifying the income information for the region in the selected level in the hierarchy of levels in the real property database; and
third program code, stored on the computer readable storage media, for displaying the income information in a graphical user interface on a display system, wherein the income information displayed in the graphical user interface on the display system enables performing an operation with respect to the real property.

18. The computer program product of claim 17 further comprising:
fourth program code, stored on the computer readable storage media, for receiving records with payroll information for people;
fifth program code, stored on the computer readable storage media, for identifying location information for the people in the records;
sixth program code, stored on the computer readable storage media, for identifying salary information for the people using the records;
seventh program code, stored on the computer readable storage media, for mapping the locations of the people into regions; and
eighth program code, stored on the computer readable storage media, for updating the income information for the regions identified, wherein the income information in the regions is updated using the salary information and the location information.

19. The computer program product of claim 18, wherein the location information is selected from at least one of a residence address or a workplace address.

20. The computer program product of claim 17, wherein the income information is selected from at least one of a rate of pay, money earned, a net pay, taxes, voluntary deductions, benefits information, and retirement contributions.

21. The computer program product of claim 17 further comprising:
fourth program code, stored on the computer readable storage media, for identifying statistical information for regions; and
fifth program code, stored on the computer readable storage media, for storing the statistical information in the real property database.

22. The computer program product of claim 21 further comprising:
sixth program code, stored on the computer readable storage media, for displaying the statistical information for the region in the graphical user interface on the display system.

23. The computer program product of claim 17, wherein third program code comprises:
program code, stored on the computer readable storage media, for displaying a map of regions in the selected level of the region in the request; and
program code, stored on the computer readable storage media, for displaying the income information in association with the map of the regions in the graphical user interface on the display system.

24. The computer program product of claim 17, wherein the region is selected from one of a census block, a block group, a census track, a county, a state, and a region of the county.
